(19) United States
(12) Patent Application Publication
(10) Pub. No.: US 2019/0291168 A1
(43) Pub. Date: Sep. 26, 2019

(54) AUTOMATED WIRE ROD TRIMMING STATION

(71) Applicant: Primetals Technologies USA LLC, Alpharetta, GA (US)

(72) Inventors: Sudhakar Teegavarapu, Hopkinton, MA (US); Matthew D. Palfreman, Charlton, MA (US); Jason Zelle, Worcester, MA (US); William X. Shen, Boylston, MA (US)

(73) Assignee: Primetals Technologies USA LLC, Alpharetta, GA (US)

(21) Appl. No.: 16/123,347

(22) Filed: Sep. 6, 2018

Related U.S. Application Data
(60) Provisional application No. 62/645,446, filed on Mar. 20, 2018.

(51) Int. Cl. B21F 11/00; B21C 47/26; B25J 11/00; B25J 9/16

(52) U.S. Cl. CPC B21F 11/00; B25J 9/1697; B25J 11/0055; B21C 47/26

(57) ABSTRACT

An automated trimming system is provided that includes a vision system that identifies the number of rings positioned within a coil and sheared positions where the rings need to be cut. One or more trimming mechanisms receive the sheared positions and proceed to cut the rings at the sheared positions. A hook arrangement interfaces with the coil for transferring the coil to a trimming area, once the coil is positioned in the trimming area the ends of the coil are separated to expose the rings positioned within using a plurality of screw rolls or the one or more trimming mechanisms.

### BACKGROUND OF THE INVENTION

The invention relates to the field of wire rod-trimming station, and in particular to an automated wire rod-trimming station.

Traditionally an inline high speed shear would be utilized to trim the head and tail of each billet “coil” rolled in the mill, the high speed shear is positioned directly before the laying head in the wire rod line and as a result must be able to trim 5.5 mm wire while travelling at 120-130 m/s. This results in a complex, machine with a complicated control system requiring high maintenance, and attention to detail to operate it correctly and consistently. Due to the complex nature of this machine it has a high capital cost and has a high operating cost as the machine utilizes two main guides, two motors of 200-300 kW and multiple switch pipes that need changing per material size to be trimmed.

### SUMMARY OF THE INVENTION

According to one aspect of the invention, there is provided an automated trimming system. The automated trimming system includes a vision system that identifies the number of rings positioned within a coil and sheared positions where the rings need to be cut. One or more trimming mechanisms receive the sheared positions and proceed to cut the rings at the sheared positions. A hook arrangement interfaces with the coil for transferring the coil to a trimming area, once the coil is positioned in the trimming area the ends of the coil are separated to expose the rings positioned within using a plurality of screw rolls or the one or more trimming mechanisms.

According to another aspect of the invention, there is provided a method of performing the operations of an automated trimming system. The method includes identifying the number of the rings positioned within a coil and sheared positions where the rings need to be cut using a vision system. Also, the method includes using one or more trimming mechanisms that receive the sheared positions and proceed to the cut the rings at the sheared positions. A hook arrangement is provided that interfaces with a coil handling area for transferring the coil to a trimming area. Furthermore, the method includes separating the ends of the coil handling system to expose the plurality rings positioned within using a plurality of screw rolls or the one or more trimming mechanisms.

### BRIEF DESCRIPTION OF THE DRAWINGS

FIGS. 1A-1C are schematic diagrams illustrating a novel trimming station used in conjunction with a coil handling system;

FIG. 2 is a schematic diagram illustrating a detailed view of a novel hook arrangement used in accordance with the invention;

FIGS. 3A-3B are schematic diagrams illustrating a detailed view of a trimming robot;

FIGS. 4A-4C are schematic diagrams illustrating the various operations of the vision system; and

FIGS. 5A-5C are schematic diagrams illustrating another embodiment of the trimming station used in conjunction with a coil handling system.

### DETAILED DESCRIPTION OF THE INVENTION

The invention involves an autonomous trimming station to be included in the coil handling area, in this area the coil has already been formed and collected and is either transported on a pallet or hook conveyance to the compactor for tying. Prior to the compactor, a new station will be included to allow the head and the tail of each coil to be trimmed automatically without operator intervention. The trim station will included a side transfer with a unique hook arrangement to allow the ends of the coils to be spread out to enable trimming of the desired number of head and tail end rings, the cutting or trimming of the rings will be made by an autonomous trimming robot, controlled via a vision system interface. The purpose of the vision system is to ensure the correct number of rings is trimmed from each coil.

High speed shears by design are not 100% reliable, while trimming coils at 120 m/s if for some reason the shear was to miss-cut the result of this can stop the mill rolling for 30 min or more with the result of a scrap coil and the lost production associated with the down time.

With the concept of trimming in the coil handling area the coil can be trimmed while stationary, a single coil may be held stationary from a minimum time of 45 secs and up depending on the production rate of the mill. The invention removes the coil from the coil handling system, via a coil down ender this is a standard product if the coil handling system is a vertical pallet system.

A custom designed hook arrangement then interfaces with the down ended coil to remove the coil and transfer the coil to the trimming station. The hook incorporates two ring separating devices that fans out the head and tail ends of the coil by a predetermined amount. This fanning may also be carried out by the trimming robot. This fanning of the coil then allows the vision system to then calculate the number of rings separated from the coil and instruct the arms of trimming robots to position the ring/rings to be cut at the shear locations. The rings are cut using a simple hydraulic shear and the arms of the trimming robots then remove the discard rings from the hook before the hook places the coil back on the down ender that then up ends the coil so that it may be transferred to the compactor for processing. If the coil is on a hook arrangement the process is similar but the down ending of the coil is not needed and the coil is transferred from hook to hook.

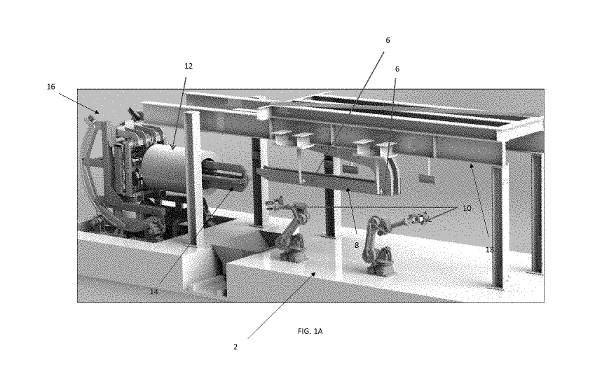

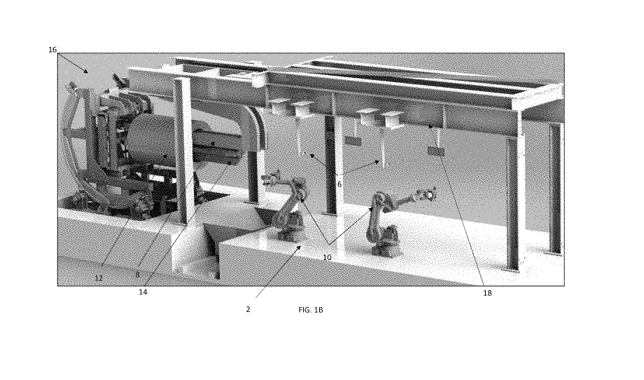

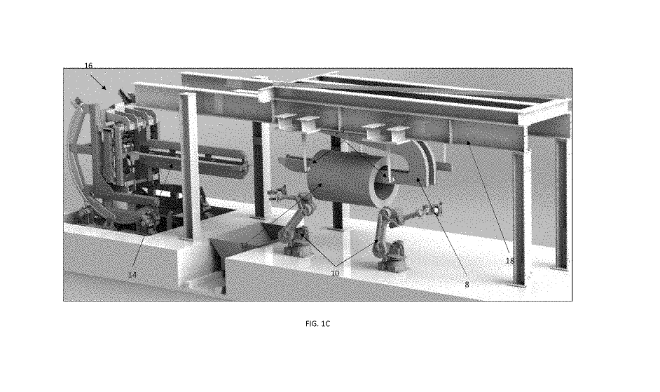

FIGS. 1A-1C are schematic diagrams illustrating the novel trimming station 2 used in conjunction with a coil handling system 12. The coil handling system 12 is positioned on a stand 14 that is part of an on-center pallet downender 16. The trimming station 2 includes a hook arrangement 8 and a number of trimming robots 10. As shown in FIG. 1A, the coil handling system 12 is brought to the downender 16 right after being processed. The stand 14 includes a number of lasers to measure and ensure accurate centering of the coils. A hook arrangement 8 is provided that interfaces with the stand 14 so as to transfer the coils, via the coil handling system 12 as shown in FIG. 1B, to the trimming station 2, as shown in FIG. 1C. The hook arrangement 8 allows the ends of the coils to be spread out to enable trimming of the desired number of head and tail end rings once at the trimming station 2.

There are a number of cameras 6 used as part of a vision system to detect the shape and edges of the coils positioned within the coil handling system 12. At the trimming station 12, the cameras are mounted on rails 18 allowing for easy movement across the coil handling system 12. The trimming robots 10 help spread the ends of the coil handling system 12 to expose the coils laid within. The vision system analyzes these coils using the cameras 6 to correctly identify the number of rings and their respective quality. Using information detected by the vision system, the trimming robots 10 correctly identify the number of rings to be trimmed from each coil. The trimming robots have selective shears specifically designed for trimming.

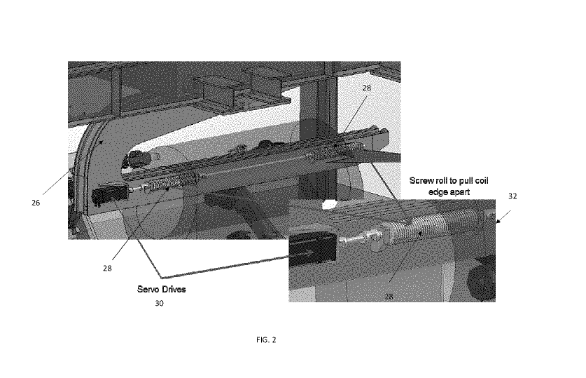

FIG. 2 is a schematic diagram illustrating a detailed view of the hook arrangement 26. The hook arrangement 24 includes a number of screw rolls 28 that are attached on each of its sides. Once the hook arrangement 26 transfers the coil handling system to the trimming station, the screw rolls 28 are used to pull the ends of the coil handling system a certain distance to produce ring separation via one of the trimming robots. A number of servo drives 30 on each side of the hook arrangement are used to pull automatically the end of the coil handling system. The vision system calculates the number of rings at the ring separation and instructs the robotic arms to position the ring/rings to be cut at the shear locations. The inlet 32 shows a detailed view of the screw rolls used in accordance with the invention. The vision system and trimming robots communicate with each other via a wireless or a control system that is either locally or remotely controlled.

Alternatively the fanning of the coil rings may be carried out by the robot itself, using a custom trimming tool, that is designed in a way to allow multipurpose use, the tool incorporates a fanning tool, the afore mentioned cutting tool and a clamping tool, to carry the cut rings to a discard position

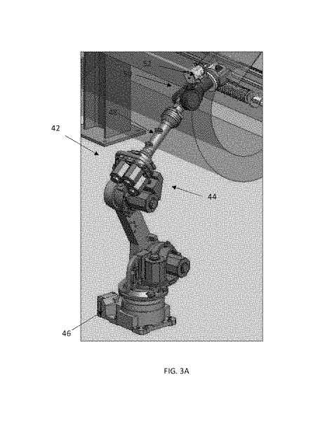

FIG. 3A is a schematic diagram illustrating a detailed view of a trimming robot 42 used in accordance with the invention. The trimming robot 42 includes an arm arrangement 44 that is coupled to a stationary surface via a stabilizer system 46. The arm arrangement 44 is coupled to a rotating shaft 48. The rotating shaft 48 is coupled to a lance and shear mechanism 50. FIG. 3B shows a detailed view of the lance and shear mechanism 50. The lance and shear mechanism 50 includes a lance 52 used to fan or separate the coils and a cutter mechanism 54 is used for trimming a coil. A grip item 60 is also included. The lance 52 and cutter and grip mechanism 54 are both positioned on a rotatable shaft 56 permitting the lance 52, the cutter mechanism 54, and the grip item 60 to rotate when in operation. The rotatable shaft 56 is positioned on an anchor mechanism 58 that permits the lance 52, the cutter mechanism 54, and the grip item 60 to move laterally when in operation.

The trimming robot 42 is a 6 axis unit that allows for flexible motion within 6 degrees of freedom. As discussed earlier, the trimming robot 42 works using information collected by one or more of the cameras 52 of the vision system to determine the appropriate positions to cut rings at various shear locations.

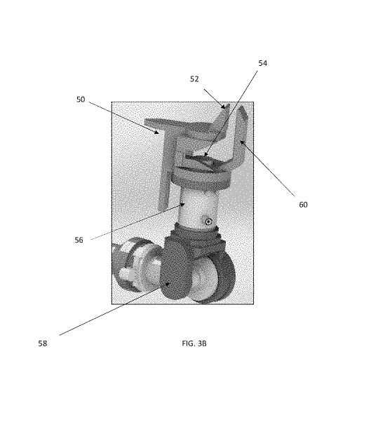

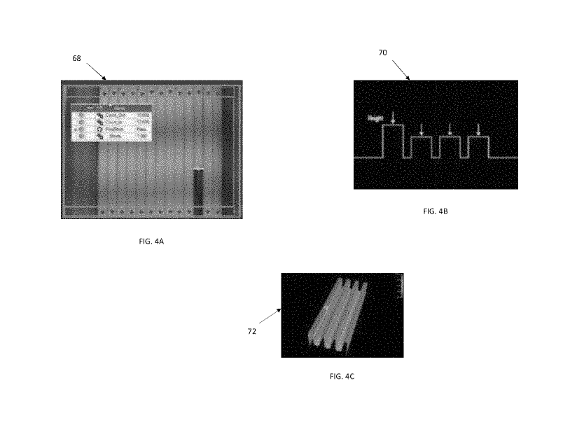

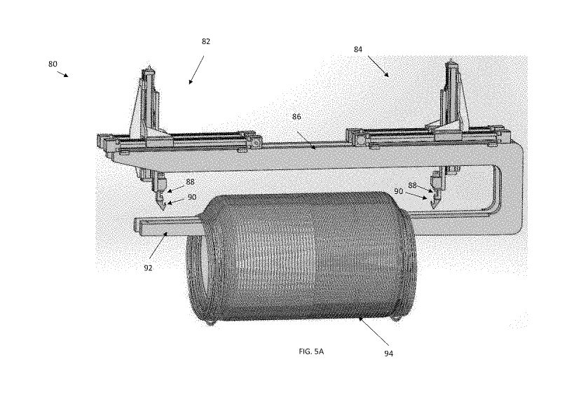

FIGS. 4A-4C are schematic diagrams illustrating the various operations of the vision system. FIG. 4A shows the profile 68 of the various coil ends positioned between the ring separation. The position of each coil is indexed by its location and sent to a controller. The controller uses this information along with the speed of the roller table to control the accurate positioning of trimming robots for shearing. FIG. 4B shows the edge/object detection 70 developed by the vision system to detect the appropriate edges of the coils. This information is provided to the controller for processing. FIG. 4C shows the depth of the field 72 of the coils being examined to determine the quality/grade, and the vision system provides this information to the controller. After receiving the various information mentioned above by the vision system, the controller evaluates the information and send respective commands to the trimming robots as to which of the evaluated coils are to be sheared and discarded.

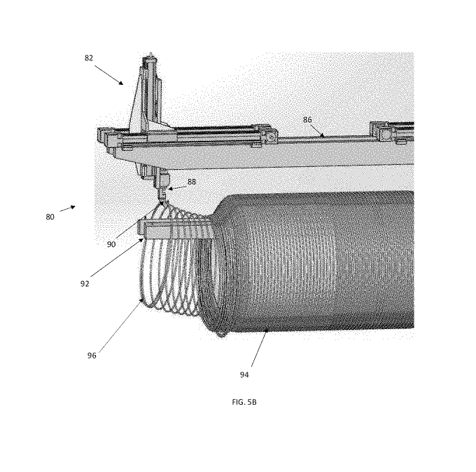

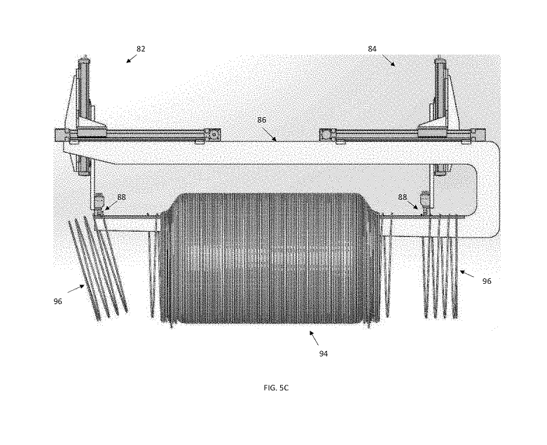

FIGS. 5A-5C are schematic diagram illustrating another embodiment of the invention. This embodiment 80 uses a pair of trimming systems 82, 84 positioned on a rail 86 that is placed above a hook arrangement 90 and a coil 94 that allows for easy movement, as shown in FIG. 5A. The hook arrangement 90 performs similarly like the aforementioned hook arrangement 8. In particular, the hook system 90 places the coil 94 in a trimming station for further processing. Each trimming system 84, 84 includes a wire cutter 88 and a hook assembly 90. Moreover, the hook assembly 90 of the trimming systems 82 is hooked to the edge of the coil 94 so as to separate the rings 96 over a latch 92 of the hook arrangement 90, as shown in FIG. 5B. The same occurs for the other trimming system 84 where the trimming systems 82, 84 are both separating the rings 96 on both ends of the coil 94 simultaneously or separately over the latch 92.

After placing the rings 96 on the latch 92, the trimming systems 82, 84 trim or cut respective ring 96 at selective locations using their wire cutters 88 at both ends of the coil 94, as shown in FIG. 5C. The determination of these specified locations is provided to the trimming systems 82, 84 by the vision system described herein. A controller is used to interface between the trimming systems 82, 84 and vision system for cutting or trimming the rings 96.

The invention provides an autonomous trimming station that includes a side transfer with a unique hook arrangement to allow the ends of the coils to be spread out to enable trimming of the desired number of head and tail end rings. By leveraging a novel vision system, the process of cutting and trimming of rings can be made by autonomous trimming mechanisms using a controller that interfaces between the trimming robots and vision system. Moreover, the vision system provides a full array of information that ensures the correct number of rings is trimmed from each coil.

Although the present invention has been shown and described with respect to several preferred embodiments thereof, various changes, omissions and additions to the form and detail thereof, may be made therein, without departing from the spirit and scope of the invention.

What is claimed is:

1. An automated trimming system comprising:
a vision system that identifies the number of rings positioned within a coil and sheared positions where the rings need to be cut;
one or more trimming mechanisms that receive the sheared positions and proceed to cut the rings at the sheared positions; and
a hook arrangement that interfaces with the coil for transferring the coil to a trimming area, once the coil is positioned in the trimming area the ends of the coil are separated to expose the rings positioned within using a plurality of screw rolls or the one or more trimming mechanisms.

2. The automated trimming system of claim I, wherein the hook arrangement interfaces with a coil handling area to transfer the coil handling system to the trimming area.

3. The automated trimming system of claim 1, wherein the screw rolls are positioned on the sides of the hook arrangement.

4. The automated trimming system of claim 1, wherein the vision system comprises a plurality of cameras.

5. The automated trimming system of claim 4, wherein the cameras are positioned on a rail to allow examination of the rings positioned within the separated ends of the coil handling system.

6. The automated trimming system of claim 1, wherein the vision system produces a profile of the exposed rings.

7. The automated trimming system of claim 1, wherein the vision system detects the appropriate edges of the exposed coils.

8. The automated trimming system of claim 1, wherein the vision system produces a depth of field view of the exposed coils.

9. The automated trimming system of claim 1, wherein the one or more trimming mechanisms comprises one or more trimming robots.

10. The automated trimming system of claim 9, wherein the one or more trimming robots receives commands for shearing the exposed rings via a controller.

11. The automated trimming system of claim 9, wherein the one or more trimming robots fan the rings to be trimmed.

12. The automated trimming system of claim 1, wherein the one or more trimming mechanisms comprise one or more trimming systems.

13. The automated trimming system of claim 12, wherein the one or more trimming systems comprise a wire cutter and a hook assembly.

14. The automated trimming system of claim 13, wherein the hook assembly is used to separate the coil to expose the rings.

15. A method of performing the operations of an automated trimming system comprising:
identifying the number of the rings positioned within a coil and sheared positions where the rings need to be cut using a vision system;
using one or more trimming mechanisms that receive the sheared positions and proceed to the cut the rings at the sheared positions;
providing a hook arrangement that interfaces with a coil handling area for transferring the coil to a trimming area; and
separating the ends of the coil handling system to expose the plurality rings positioned within using a plurality of screw rolls or the one or more trimming mechanisms.

16. The method of claim 15, wherein the hook arrangement interfaces with a coil handling area to transfer the coil handling system to the trimming area.

17. The method of claim 15, wherein the screw rolls are positioned on the sides of the hook arrangement.

18. The method of claim 15, wherein the vision system comprises a plurality of cameras.

19. The method of claim 18, wherein the cameras are positioned on a rail to allow examination of the rings positioned within the separated ends of the coil handling system.

20. The method of claim 15, wherein the vision system produces a profile of the exposed rings.

21. The method of claim 15, wherein the vision system detects the appropriate edges of the exposed coils.

22. The method of claim 15, wherein the vision system produces a depth of field view of the exposed coils.

23. The method of claim 15, wherein the one or more trimming mechanisms comprises one or more trimming robots.

24. The method of claim 23, wherein the one or more trimming robots receives commands for shearing the exposed rings via a controller.

25. The method of claim 23, wherein the one or more trimming robots fan the rings to be trimmed.

26. The method of claim 15, wherein the one or more trimming mechanisms comprise one or more trimming systems.

27. The method of claim 26, wherein the one or more trimming systems comprise a wire cutter and a hook assembly.

28. The method of claim 27, wherein the hook assembly is used to separate the coil to expose the rings.
